(19) United States
(12) Patent Application Publication
(10) Pub. No.: US 2026/0192671 A1
(43) Pub. Date: Jul. 9, 2026

(54) DISPLAY CONTROL DEVICE

(71) Applicant: TOYOTA JIDOSHA KABUSHIKI KAISHA, Toyota-shi (JP)

(72) Inventors: Yasuaki NADAYA, Toyota-shi (JP); Yuki TSURUTA, Nagoya-shi (JP)

(73) Assignee: TOYOTA JIDOSHA KABUSHIKI KAISHA, Toyota-shi (JP)

(21) Appl. No.: 19/382,379

(22) Filed: Nov. 7, 2025

(30) Foreign Application Priority Data
Jan. 8, 2025 (JP) 2025-003051

(51) Int. Cl. B60K 35/81; B60K 35/10; B60K 35/29

(52) U.S. Cl. CPC B60K 35/81; B60K 35/10; B60K 35/29; B60K 2360/167

(57) ABSTRACT

A display control device includes: an acquisition unit that acquires predetermined identification information for identifying a vehicle; a predetermined frame that is provided in front of a vehicle of a driver's seat of the vehicle and defines a range in which a driver can visually recognize a plurality of vehicles including the vehicle, and display data to the display unit including an instrument image indicating information of an instrument of the vehicle and a background image indicating a background of the instrument image, the display data including an image having a dimension larger than the predetermined frame; and an adjustment unit that moves the predetermined frame to a position where the instrument image corresponding to the vehicle identified based on the identification information acquired by the acquisition unit becomes visually recognizable, and adjusts a positional relationship of the display data with respect to the predetermined frame.

### CROSS-REFERENCE TO RELATED APPLICATION

This application claims priority to Japanese Patent Application No. 2025-003051 filed on January 8, 2025. The disclosure of the above-identified application, including the specification, drawings, and claims, is incorporated by reference herein in its entirety.

### BACKGROUND

### 1. Technical Field

The present disclosure relates to a display control device.

### 2. Description of Related Art

Japanese Unexamined Patent Application Publication No. 2014-098665 (JP 2014-098665 A) discloses a technique in which a vehicle speed of a vehicle, a current shift state of a transmission, and the like are displayed on a display screen of a meter unit.

### SUMMARY

It is conceivable that a plurality of vehicles achieves commonality of the dimensions of a display unit that displays vehicle information indicating a vehicle state such as the vehicle speed and the shift state described in JP 2014-098665 A, together with a background image indicating the background of the vehicle information. However, the range of the display unit that can be visually recognized by a driver seated in a driver's seat differs depending on the presence or absence of the decoration of each vehicle, the arrangement of the mounted components, etc., and therefore, there is a possibility that a part of the vehicle information may not be seen in some vehicles, and it may be difficult to achieve commonality of the display unit.

Therefore, an object of the present disclosure is to provide a display control device capable of increasing the number of vehicles for which commonality of the dimensions of a display unit provided on a vehicle front side of a driver's seat can be achieved.

An aspect of the present disclosure provides a display control device including:

an acquisition unit that acquires predetermined identification information for identifying a vehicle, a predetermined frame that defines a range that is visually recognizable by a driver in a display unit provided on a vehicle front side of a driver’s seat of the vehicle and having dimensions that are identical to dimensions of display units of a plurality of vehicles including the vehicle, and display data to be displayed on the display unit, the display data being constituted of an image being larger in dimensions than the predetermined frame and including an instrument image indicating information on an instrument of the vehicle and a background image indicating a background of the instrument image; and

an adjustment unit that adjusts a positional relationship of the display data with respect to the predetermined frame by moving the predetermined frame to a position where the instrument image corresponding to the vehicle identified based on the identification information acquired by the acquisition unit is visually recognizable.

In the display control device according to this aspect, the acquisition unit acquires predetermined identification information, a predetermined frame, and display data. Then, the adjustment unit adjusts the positional relationship of the display data with respect to the predetermined frame by moving the predetermined frame to a position where the instrument image corresponding to the vehicle identified based on the identification information acquired by the acquisition unit is visually recognizable. Thus, with the display control device, the driver can visually recognize the instrument image displayed on the display unit by moving the predetermined frame to a position where the instrument image corresponding to the identified vehicle can be visually recognized. Therefore, with the display control device, it is possible to increase the number of vehicles for which commonality of the dimensions of the display unit can be achieved.

In the display control device according to the above aspect,

the adjustment unit may be configured to receive an instruction from the driver to move the display data displayed on the display unit of the vehicle, and move the display data to a display position specified by the driver when the specified display position is within a movable range prescribed in advance.

In the display control device according to this aspect, the adjustment unit moves the display data to a display position specified by the driver when the specified display position is within a movable range. Thus, with the display control device, it is possible to achieve customization by moving the display data to a display position desired by the driver within the movable range prescribed in advance.

In the display control device according to the above aspect,

the adjustment unit may be configured to cause the display unit to display instruction information giving an instruction to move the display data into the movable range when the display position specified by the driver is outside the movable range.

In the display control device according to this aspect, the adjustment unit causes the display unit to display instruction information giving an instruction to move the display data into the movable range when the display position specified by the driver is outside the movable range. Thus, with the display control device, it is possible to restrict the movement of the display data to the outside of the movable range prescribed in advance, even when the driver desires so.

In the display control device according to the above aspect,

the display data may be composed of a plurality of individual regions; and

the adjustment unit may be configured to receive an instruction from the driver to move a display position for individual regions, and move an individual region to a display position when the display position of the individual region for which the instruction for movement has been received is within the movable range.

In the display control device according to this aspect, the adjustment unit receives an instruction from the driver to move a display position for individual regions, and moves an individual region to a display position when the display position of the individual region for which the instruction for movement has been received is within the movable range. Thus, with the display control device, it is possible to increase the degree of freedom of customization of the display position of the display data as compared with a configuration in which only the movement of the display data as a whole is possible.

In the display control device according to the above aspect,

the adjustment unit may be configured to suppress movement to a display position when a degree of overlap of the individual region specified by the driver at the display position with another individual region exceeds a predetermined width.

In the display control device according to this aspect, the adjustment unit suppresses movement to a display position when the degree of overlap of the individual region specified by the driver at the display position with another individual region exceeds a predetermined width. Thus, according to the display control device, it is possible to suppress a reduction in the visibility of the instrument image as compared with a configuration in which there is no restriction on the degree of overlap between the individual regions.

As described above, with the display control device according to the present disclosure, it is possible to increase the number of vehicles for which commonality of the dimensions of a display unit provided on a vehicle front side of a driver's seat can be achieved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a hardware configuration of a vehicle;

FIG. 2 is a first explanatory diagram illustrating an example of adjusting a positional relationship of display data with respect to a predetermined frame;

FIG. 3 is a second explanatory diagram illustrating an example of adjusting the positional relationship of the display data with respect to the predetermined frame;

FIG. 4 is a flowchart illustrating a flow of a specific process;

FIG. 5A is an example of a first display example displayed on a monitor (an example of an adjusted status after moving display data to a display position instructed by a driver);

FIG. 5B is another example of the first display example displayed on the monitor (an example in which the instruction information is displayed on the monitor); and

FIG. 6 is a second display example displayed on the monitor.

### DETAILED DESCRIPTION OF EMBODIMENTS

Hereinafter, the vehicle 10 according to the present embodiment will be described.

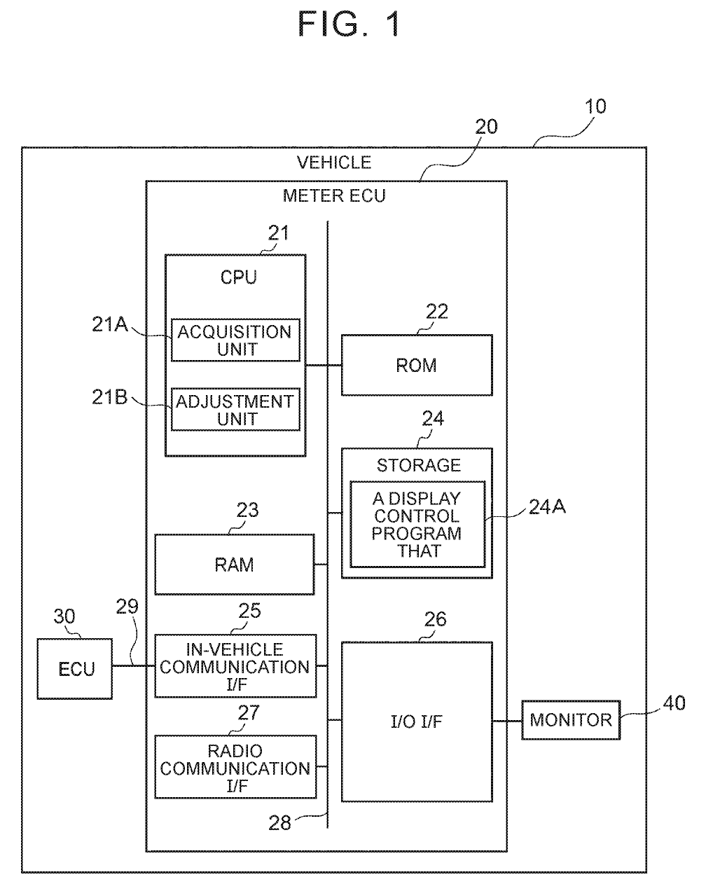

FIG. 1 is a block diagram illustrating a hardware configuration of a vehicle 10. As illustrated in FIG. 1, the vehicles 10 include a meter ECU (Electronic Control Unit) 20. The vehicle 10 is an example of a "vehicle" of the present disclosure, and the meter ECU 20 is an example of a "display control device" of the present disclosure.

The meter ECU 20 includes CPU (Central Processing Unit) 21, ROM (Read Only Memory) 22, RAM (Random Access Memory) 23, storage 24, in-vehicle communication I/F (InterFace) 25, input/output I/F 26, and radio communication I/F 27. CPU 21, ROM 22, RAM 23, the storage 24, the in-vehicle communication I/F 25, the input/output I/F 26, and the radio communication I/F 27 are communicably connected to each other via an inner bus 28.

CPU 21 is a central processing unit that executes various programs and controls each unit. That is, CPU 21 reads the program from ROM 22 or the storage 24, and executes the program using RAM 23 as a working area. CPU 21 performs control of the above-described configurations and various arithmetic processes in accordance with programs recorded in ROM 22 or the storage 24.

ROM 22 stores various programs and various data. RAM 23 temporarily stores a program/data as a working area.

The storage 24 is constituted by a storage device such as an eMMC (embedded MultiMedia Card) or a UFS (Universal Flash Storage), and stores various programs and various data. The storage 24 stores a display control program 24A. The display control program 24A is a program for causing CPU 21 to execute various processes to be described later.

The in-vehicle communication I/F 25 is an interface for connecting to another ECU30. The interface uses a CAN protocol-based communication standard. The in-vehicle communication I/F 25 is connected to an external bus 29. Although not shown, a plurality of ECU is provided for each function of the vehicles 10 in addition to ECU30.

The input/output I/F 26 is an interface for communicating with the monitor 40 mounted on the vehicles 10.

The monitor 40 is a meter display provided on a meter panel disposed in front of a driver's seat of the vehicle 10 and for displaying an operation proposal related to the function of the vehicle 10, an image related to the explanation of the function, and the like. In the present embodiment, the monitor 40 has a common dimension in a plurality of vehicles including the vehicle 10. The monitor 40 is an example of a "display unit" of the present disclosure.

The wireless communication I/F 27 is a wireless communication module for communicating with an external device. As the radio communication module, for example, communication standards such as 5G, LTE, Wi-Fi (registered trademark) and Bluetooth (registered trademark) are used.

Further, CPU 21 of the meter ECU 20 has, as a functional configuration, an acquisition unit 21A and an adjustment unit 21B. The respective functional configurations are realized by CPU 21 reading and executing the display control program 24A stored in the storage 24. The acquisition unit 21A is an example of the "acquisition unit" of the present disclosure, and the adjustment unit 21B is an example of the "adjustment unit" of the present disclosure.

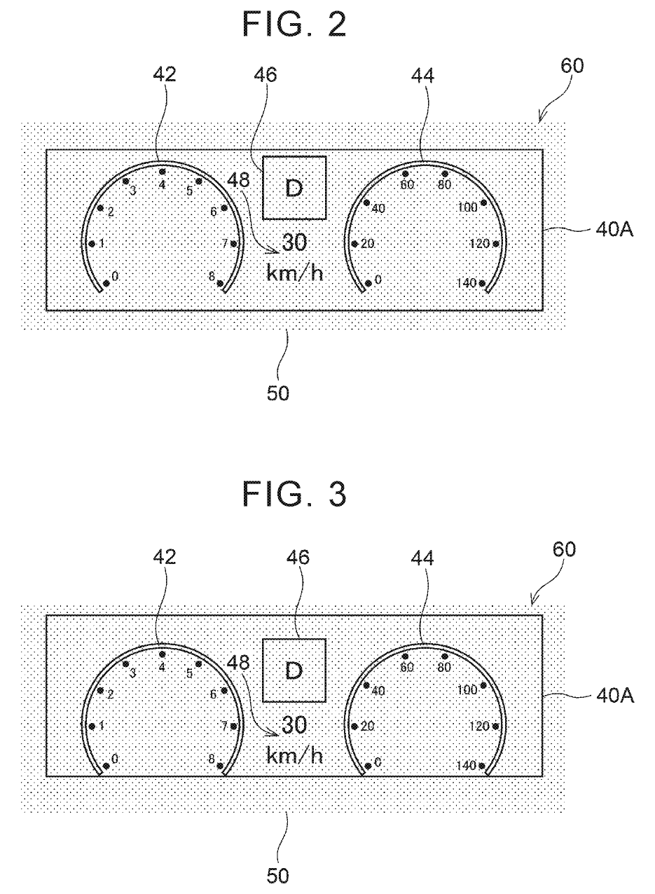

The acquisition unit 21A acquires various types of data. For example, the acquisition unit 21A acquires, from the storage 24, a vehicle identification number that is predetermined identification information for identifying the vehicle 10 as various types of information. In addition, the acquisition unit 21A acquires, from the storage 24, a predetermined frame 40A (refer to FIG. 2 and the like) defining a range in which the driver can visually recognize the range on the monitor 40 as various types of information. Further, the acquisition unit 21A acquires, from the storage 24, display data 60 (see FIG. 2 and the like) on the monitor 40 including, as various kinds of information, vehicle information indicating a state of the vehicle 10 including instrument images 42 and 44 (see FIG. 2 and the like) indicating information of the tachometer and the speedometer, and a background image 50 (see FIG. 2 and the like) indicating a background of the vehicle information, and including an image having a size larger than a predetermined frame 40A. The predetermined frame 40A is an example of the "predetermined frame" of the present disclosure, the tachometer and the speedometer are examples of the "instrument of vehicles" of the present disclosure, the instrument images 42 and 44 are examples of the "instrument image" of the present disclosure, the background image 50 is an example of the "background image" of the present disclosure, and the display data 60 is an example of the "display data" of the present disclosure.

In the present embodiment, as an example, the vehicle information includes instrument images 42 and 44, shift information 46 (see FIG. 2 and the like) indicating the shift position of the vehicle 10, and vehicle speed information 48 (see FIG. 2 and the like) indicating the vehicle speed of the vehicle 10. The acquisition unit 21A acquires the above-described various pieces of information from the storage 24 at predetermined timings at the time of manufacturing the vehicle 10.

The adjustment unit 21B moves the predetermined frame 40A to a position where the vehicle information corresponding to the vehicle 10 identified based on the vehicle identification number acquired by the acquisition unit 21A can be visually recognized, and adjusts the positional relation of the display data 60 with respect to the predetermined frame 40A. Here, the "position at which the vehicle information is visible" may be referred to as a "position at which the vehicle information cannot be seen from the monitor 40", a "position at which the vehicle information does not protrude from the monitor 40", a "position at which all the vehicle information is displayed in the monitor 40", and the like. Here, the storage 24 stores information indicating the arrangement of the predetermined frame 40A for each vehicle type. The adjustment unit 21B acquires information indicating the arrangement of the predetermined frame 40A according to the vehicle type identified based on the vehicle identification number from the storage 24, and moves the predetermined frame 40A to the arrangement indicated by the information.

FIG. 2 is a first explanatory diagram illustrating an exemplary adjustment of the positional relation of the display data 60 with respect to the predetermined frame 40A.

FIG. 2 shows the predetermined frame 40A and the display data 60. For example, the predetermined frame 40A is a rectangular frame, but the form of the frame is not particularly limited. Further, in FIG. 2, the instrument image 42, the instrument image 44, the shift information 46, the vehicle speed information 48, and the background image 50 are shown as the display data 60. The instrument image 42 is an image of a tachometer indicating the engine rotational speed of the vehicle 10, and the instrument image 44 is an image of a speedometer indicating the vehicle speed of the vehicle 10. The background image 50 shows the background of the vehicle information including the instrument image 42, the instrument image 44, the shift information 46, and the vehicle speed information 48 using a predetermined color, pattern, and the like. Note that FIG. 2 shows a situation where the positional relation of the display data 60 with respect to the predetermined frame 40A is adjusted at the time of manufacturing the vehicle 10, but the shift information 46 and the vehicle speed information 48 show specific shift positions and vehicle speeds in order to facilitate understanding of the drawings.

The display data 60 has a rectangular shape as a whole, and its dimensions are larger than a predetermined frame 40A in both the vertical dimension and the horizontal dimension. Note that the shape of the display data 60 is not particularly limited as long as the size is larger than the predetermined frame 40A.

Here, FIG. 2 illustrates a case where a predetermined frame 40A is moved to a position where vehicle data corresponding to the vehicle 10 can be visually recognized among a plurality of vehicles having the same dimensions of the monitor 40. Therefore, all the pieces of vehicle-information illustrated in FIG. 2 fall within the predetermined frame 40A. As a result, the driver of the vehicle 10 manufactured by the positional relation of the display data 60 with respect to the predetermined frame 40A shown in FIG. 2 can visually recognize all the vehicle information displayed on the monitor 40 of the vehicle 10.

FIG. 3 is a second explanatory diagram illustrating an exemplary positional relation of the display data 60 with respect to the predetermined frame 40A. Specifically, FIG. 3 illustrates a case where the predetermined frame 40A is moved to a position where vehicle information corresponding to another vehicle different from the vehicle 10 can be visually recognized among a plurality of vehicles in which the dimensions of the monitor 40 are shared.

Here, the predetermined frame 40A shown in FIG. 3 is positioned slightly above FIG. 2. Therefore, in FIG. 3, the positional relation of the display data 60 with respect to the predetermined frame 40A is different from that in FIG. 2. However, in FIG. 3, as in FIG. 2, all of the vehicle information is within the predetermined frame 40A. As a result, the driver of the other vehicle manufactured by the positional relation of the display data 60 with respect to the predetermined frame 40A shown in FIG. 3 can visually recognize all the vehicle information displayed on the monitor 40 of the other vehicle.

As described above, in the meter ECU 20, CPU 21 acquires the vehicle identification number, the predetermined frame 40A, and the display data 60 from the storage 24. Then, CPU 21 moves the predetermined frame 40A to a position where the vehicle information corresponding to the vehicle 10 identified based on the acquired vehicle identification number can be visually recognized, and adjusts the positional relation of the display data 60 with respect to the predetermined frame 40A. Thus, according to the meter ECU 20, by moving the predetermined frame 40A to a position where the vehicle information corresponding to the identified vehicle can be visually recognized, the driver can visually recognize all the vehicle information displayed on the monitor 40. Therefore, according to the meter ECU 20, it is possible to increase the number of vehicles capable of sharing the dimensions of the monitor 40.

Here, even if the vehicle 10 is manufactured by moving the predetermined frame 40A to a position where the vehicle information corresponding to the vehicle 10 can be visually recognized, the appearance of the vehicle information displayed on the monitor 40 may differ depending on the physique of the driver or the like. Therefore, in the vehicle 10 according to the present embodiment, the display data 60 can be moved to the display position instructed by the driver. Hereinafter, the details will be described.

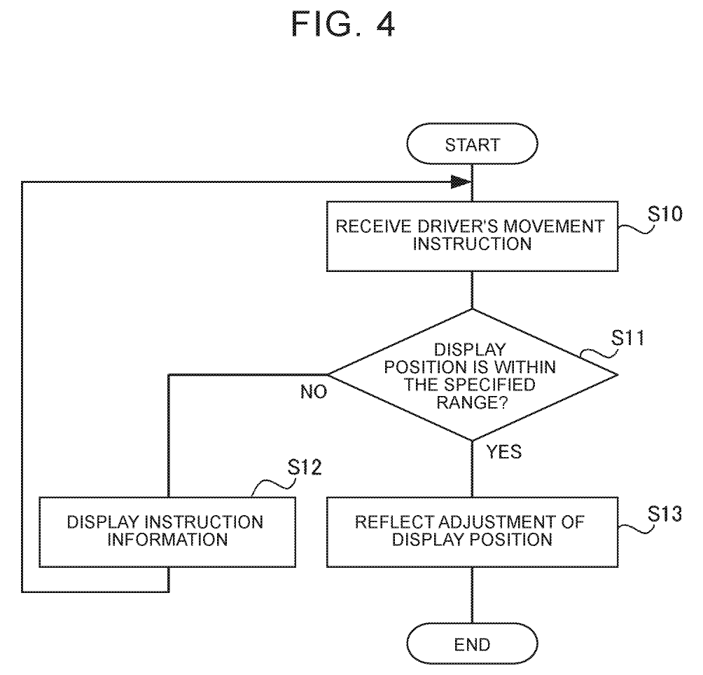

FIG. 4 is a flowchart illustrating a flow of a specifying process executed by the meter ECU 20. CPU 21 reads the display control program 24A from the storage 24, develops it in RAM 23, and executes it, thereby performing the specifying process. As an example, the specifying process is performed when the adjustment mode for adjusting the display position of the display data 60 is set in the vehicle 10.

In S10 illustrated in FIG. 4, the adjustment unit 21B receives an instruction to move the display data 60 displayed on the monitor 40 by the driver. The driver inputs a movement instruction for the display position by operating various switches (not shown) provided in the vehicle 10. Then, the identifying process proceeds to S11.

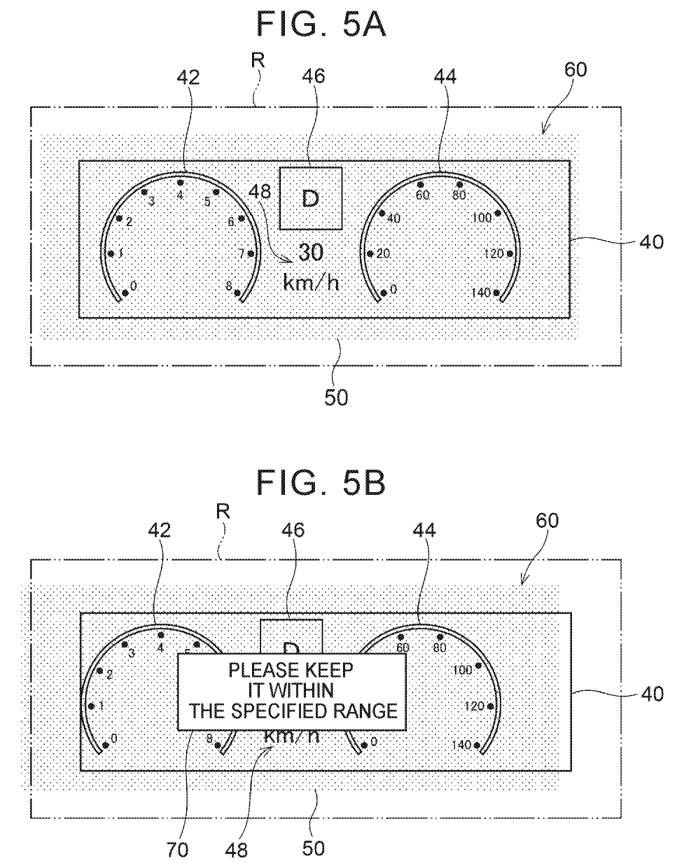

In S11, the adjustment unit 21B determines whether or not the displayed position instructed by the driver in S10 is within the specified range R (refer to FIGS. 5A, 5B, and the like). In the present embodiment, a specified range R indicating a movable range of the display data 60 is defined in advance. The specified range R is an example of the "movable range" of the present disclosure. Here, when the adjustment unit 21B determines that the displayed position instructed by the driver is within the specified range R (S11: YES), the process proceeds to S13. On the other hand, when the adjustment unit 21B determines that the displayed position instructed by the driver is not within the specified range R, that is, is outside the specified range R (S11: NO), the process proceeds to S12.

In S12, the adjustment unit 21B causes the monitor 40 to display the instruction information 70 (refer to FIG. 5B) that instructs the display data 60 to be within the specified range R. Then, the identifying process returns to S10.

In S13, the adjustment unit 21B reflects the adjustment of the display position instructed by the driver in S10, and moves the display data 60 to the display position. Then, the identification process ends.

FIGS. 5A and 5B are first explanatory diagrams illustrating exemplary displays of the monitor 40. Specifically, FIG. 5A shows a first exemplary adjusted state after the display data 60 is moved to the display position instructed by the driver. In addition, FIG. 5B shows that the instruction information 70 is displayed on the monitor 40.

As shown in phantom lines in FIGS. 5A and 5B, in the present embodiment, the specified range R is defined in advance. As an example, the specified range R is larger in both the vertical dimension and the horizontal dimension than the display data 60. The specified range R is dimensioned so as not to create a background portion or a non-background portion within the monitor 40. That is, in the case where the background image 50 of the display data 60 is within the specified range R, there is no background portion or no background portion in the monitor 40. Here, the specified range R is a range in which it is difficult for the driver to feel uncomfortable with respect to the display content of the monitor 40 when the display data 60 is displayed because there is no background portion and no portion in the monitor 40. On the other hand, since a portion having a background and a portion having no background in the monitor 40 may occur outside the specified range R, it can be said that the range easily gives a sense of discomfort to the driver regarding the display content of the monitor 40 when the display data 60 is displayed.

Here, in the adjusted state shown in FIG. 5A, since the background images 50 are not partially outside the specified range R at the display position instructed by the driver, the display data 60 is moved to the display position assuming that the display position is within the specified range R.

On the other hand, in the condition shown in FIG. 5B, since the left end part of the background image 50 is outside the specified range R at the display position instructed by the driver, the instruction information 70 is displayed on the monitor 40 assuming that the display position is outside the specified range R. In FIG. 5B, the text "Please keep within the specified range" is displayed as the instruction information 70. The instruction information 70 is an example of "instruction information" of the present disclosure.

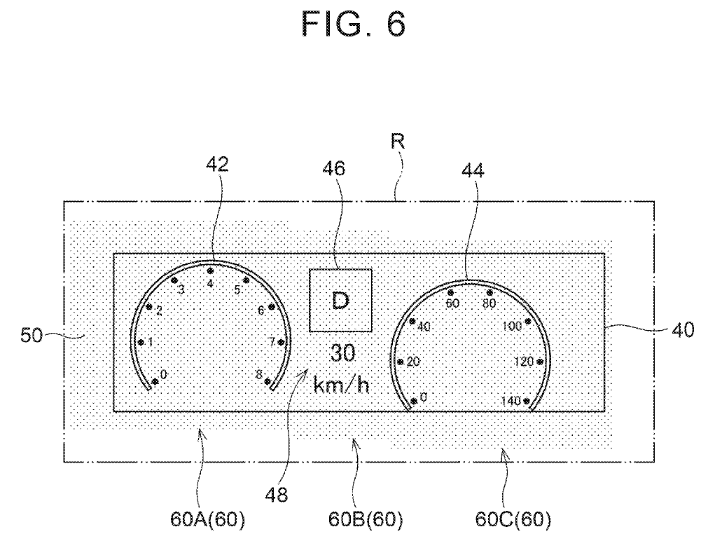

FIG. 6 is a second explanatory diagram illustrating a display example of the monitor 40. Specifically, FIG. 6 shows a second example of the adjusted state after the display data 60 is moved to the display position instructed by the driver.

In the present embodiment, as illustrated in FIG. 6, the display data 60 may include a plurality of individual regions, for example, a region 60A, a region 60B, and a region 60C. By combining the region 60A, the region 60B, and the region 60C, the same dimensions as those of the display data 60 illustrated in FIG. 5 and the like are obtained. The region 60A, the region 60B, and the region 60C are exemplary of the "plurality of individual areas" disclosed herein.

When the display data 60 is configured as described above, the adjustment unit 21B receives an instruction to move the display position in units of individual areas by the driver, and when the display position of the individual area in which the movement instruction is received is within the specified range R, moves the individual area to the display position.

The adjusted status illustrated in FIG. 6 indicates that the display positions of the region 60A, the region 60B, and the region 60C are moved and all the display positions of the region 60A, the region 60B, and the region 60C are within the specified range R. Therefore, in the adjusted condition, the region 60A, the region 60B, and the region 60C constituting the display data 60 are moved from their original positions.

As described above, in the meter ECU 20, when the display position instructed by the driver is within the specified range R, CPU 21 moves the display data 60 to the display position. Accordingly, according to the meter ECU 20, the display data 60 can be customized to be moved to a display position desired by the driver within the specified range R in which it is difficult for the driver to feel uncomfortable with respect to the display content of the monitor 40 when the display data 60 is displayed.

Further, in the meter ECU 20, when the display position instructed by the driver is outside the specified range R, CPU 21 causes the monitor 40 to display the instruction information 70 instructing the display data 60 to be within the specified range R. Thus, according to the meter ECU 20, even when the driver desires, it is possible to restrict the display data 60 from being moved outside the specified range R that easily gives the driver an uncomfortable feeling regarding the display content of the monitor 40 when the display data 60 is displayed.

Further, in the meter ECU 20, CPU 21 receives an instruction to move the display position in units of individual areas by the driver, and moves the individual area to the display position when the display position of the individual area for which the instruction to move has been received is within the specified range R. As a result, according to the meter ECU 20, it is possible to increase the degree of flexibility in customizing the display position of the display data 60 as compared with a configuration in which only the entire display data 60 can be moved.

Further, in the meter ECU 20, as a function of the adjustment unit 21B, CPU 21 suppresses the driver moving to the display position when the degree of overlap with another individual region at the display position of the individual region instructed by the driver exceeds a predetermined range. The predetermined width is determined in advance as a width at which the visibility of the vehicle information is reduced due to the overlap between the individual regions. Accordingly, according to the meter ECU 20, it is possible to suppress a decrease in visibility of the vehicle-information as compared with a configuration in which the degree of overlap between the individual regions is not limited.

### Other

Although the embodiments of the present disclosure have been described in detail with reference to the accompanying drawings, the technical scope of the present disclosure is not limited to such examples. It will be apparent to those skilled in the art that various modifications and variations can be made within the scope of the technical idea described in the claims, and these modifications and variations are of course within the technical scope of the present disclosure.

Further, the effects described in the above embodiments are illustrative or exemplary, and are not limited to those described in the above embodiments. That is, the technology according to the present disclosure can produce other effects that are obvious to a person having ordinary knowledge in the technical field of the present disclosure from the description in the above embodiment, together with the effects described in the above embodiment or instead of the effects described in the above embodiment.

The processing described in the above embodiment can also be realized by a dedicated hardware circuit. In this case, it may be executed by one piece of hardware or by a plurality of pieces of hardware.

In the above-described embodiment, the display control program 24A is stored in the storage 24. However, the present disclosure is not limited thereto, and the display control program 24A may be stored in ROM 22.

In the above-described embodiment, the monitor 40, which is a meter display, is an example of the "display unit" of the present disclosure, but the example of the "display unit" is not limited to the meter display. For example, an example of "display unit" may be other displays, such as a center display and a head-up display (HUD). An example of the "display unit" may be a combination of a plurality of displays such as a meter display and a center display.

In the above-described embodiment, the display data 60 is movable in both the up-down direction and the left-right direction in the monitor 40, but the direction in which the display data 60 is movable is not particularly limited. For example, the display data 60 may be movable in only one of the up-down direction and the left-right direction. Similarly, the direction in which the predetermined frame 40A can move is not particularly limited.

In the above-described embodiment, when the display data 60 is composed of a plurality of individual regions, individual regions that cannot be moved may be provided in the plurality of individual regions. In the case where the display position can be moved in units of individual regions, the individual regions may be moved to a position where they overlap each other.

In the above embodiment, the meter ECU 20 executes the specifying process illustrated in FIG. 4. However, the present disclosure is not limited thereto, and the specifying process may be executed by the meter ECU 20 and other ECU in cooperation with each other.

It should be noted that the identifying process executed by CPU 21 reading the software (program) in the above-described embodiment may be executed by various processors other than CPU. The processor in this case includes an exclusive electric circuit that is a processor including a circuit configuration exclusively designed for executing specific processing, such as programmable logic device (PLD) having a circuit configuration that can be changed after the manufacture including a field-programmable gate array (FPGA), and an application specific integrated circuit (ASIC). Further, the specifying process may be executed by one of these various processors, or may be executed by a combination of two or more processors (for example, a plurality of FPGA, a combination of CPU and FPGA, and the like) of the same type or different types. Further, a hardware structure of the various processors is, more specifically, an electric circuit in which circuit elements such as semiconductor elements are combined.

In the above embodiment, the display control program 24A is stored (installed) in the storage 24 in advance, but the present disclosure is not limited thereto. The display control program 24A may be provided in a form recorded in a recording medium such as CD-ROM (Compact Disk Read Only Memory), DVD-ROM (Digital Versatile Disk Read Only Memory), and USB (Universal Serial Bus). In addition, the display control program 24A may be downloaded from an external device via a network. Note that the technology of the present disclosure can also be applied to programs and program products.

What is claimed is:

1. A display control device comprising:
an acquisition unit that acquires predetermined identification information for identifying a vehicle, a predetermined frame that defines a range that is visually recognizable by a driver in a display unit provided on a vehicle front side of a driver’s seat of the vehicle and having dimensions that are identical to dimensions of display units of a plurality of vehicles including the vehicle, and display data to be displayed on the display unit, the display data being constituted of an image being larger in dimensions than the predetermined frame and including an instrument image indicating information on an instrument of the vehicle and a background image indicating a background of the instrument image; and
an adjustment unit that adjusts a positional relationship of the display data with respect to the predetermined frame by moving the predetermined frame to a position where the instrument image corresponding to the vehicle identified based on the identification information acquired by the acquisition unit is visually recognizable.

2. The display control device according to claim 1, wherein the adjustment unit is configured to receive an instruction from the driver to move the display data displayed on the display unit of the vehicle, and move the display data to a display position specified by the driver when the specified display position is within a movable range prescribed in advance.

3. The display control device according to claim 2, wherein the adjustment unit is configured to cause the display unit to display instruction information giving an instruction to move the display data into the movable range when the display position specified by the driver is outside the movable range.

4. The display control device according to claim 2, wherein:
the display data are composed of a plurality of individual regions; and
the adjustment unit is configured to receive an instruction from the driver to move a display position for individual regions, and move an individual region to a display position when the display position of the individual region for which the instruction for movement has been received is within the movable range.

5. The display control device according to claim 4, wherein the adjustment unit is configured to suppress movement to a display position when a degree of overlap of the individual region specified by the driver at the display position with another individual region exceeds a predetermined width.
